(19) United States
(12) Patent Application Publication
(10) Pub. No.: US 2002/0012088 A1
(43) Pub. Date: Jan. 31, 2002

(54) Liquid crystal device, projection type display apparatus, and electronic apparatus

(75) Inventors: Kinya Ozawa, Suwa-shi (JP); Tsuyoshi Maeda, Ryuo-cho (JP)

Correspondence Address: OLIFF & BERRIDGE, PLC, P.O. BOX 19928, ALEXANDRIA, VA, 22320, US

(73) Assignee: Seiko Epson Corporation

(21) Appl. No.: 09/835,491

(22) Filed: Apr. 17, 2001

(30) Foreign Application Priority Data
Apr. 17, 2000 (JP) 2000-115207
Mar. 7, 2001 (JP) 2001-064073

(51) Int. Cl. G02F 1/1337

(52) U.S. Cl. 349/123

(57) ABSTRACT

The invention provides a liquid crystal device and a projection type display apparatus, having capability of performing high contrast display by suppressing the generation of display defects caused by disclination in a highly fine projection type liquid crystal panel. According to the present invention, a liquid crystal layer is disposed between one substrate and another substrate, and on the one substrate, pixel electrodes aligned in a matrix and TFTs driving the plurality of pixel electrodes are provided. In the structure described above, when the thickness of the liquid crystal between the substrates and the spaces between the pixel electrodes are represented by d and L, respectively, and when an alignment angle (a pretilt angle) of the liquid crystal is represented by θp, the θp is in a range of 20 to 30°, and d/L is 1 or more.

### BACKGROUND OF THE INVENTION

1. Field of Invention

The present invention relates to a liquid crystal device in which the pretilt angle of an alignment film, the space between pixel electrodes, and the thickness of the liquid crystal layer have a specific relationship, and to a projection type display apparatus and an electronic apparatus using the liquid crystal device. The present invention particularly relates to a technique for reducing display defects caused by disclination lines.

2. Description of Related Art

The demand for liquid crystal devices has been increasing by virtue of the spread of projection type display apparatuses, such as projection television, in addition to direct view type display apparatuses. When a liquid crystal device is used for a projection type display apparatus, and when the magnifying rate is increased without increasing the number of pixels, the coarseness of the screen becomes observable. Accordingly, in order to obtain fine images with a high magnification rate, the number of pixels must be increased.

However, when the number of pixels is increased, while the area of the liquid crystal device is maintained, and in particular in the case of an active matrix liquid crystal device, since the areas for the wiring portions and switching element portions, other than the pixels, are relatively increased, the area of a black matrix covering the portions mentioned above is increased.

In addition, in the case described above, a problem may arise in that since the distance between pixels, i.e., the space between the pixel electrodes, is inevitably decreased, when attention is given to one pixel electrode, disclination (rotation and inclination of liquid crystal molecules) is likely to occur due to the influence of an electric field from the periphery of another adjacent pixel electrode. When disclination occurs, in addition to the wiring portions and switching element portions, the areas at which it occurs must be covered with the black matrix.

As described above, when the number of pixels is increased, while the area of the liquid crystal device is maintained, since the areas at which the disclination occurs, in addition to the areas of the wiring portions and the switching element portions, must be covered with the black matrix, the areas of the black matrix is significantly increased with respect to the display area. Accordingly, in the case described above, areas of apertures for the pixels contributing to the display are decreased, that is, the aperture ratio is decreased. Hence, a problem may arise in that the display image is darkened, and image quality is degraded.

Next, a display defect caused by disclination will be described. A liquid crystal device having a highly fine structure for use in a current projection type display apparatus is provided with a plurality of rectangular pixel electrodes, aligned in a matrix, each having a small width of approximately 20×10⁻⁶ m(20 μm). In addition, in the highly fine liquid crystal device, when a reflective structure is employed, the pixel electrodes are aligned with small spaces therebetween on an insulating film covering the switching elements formed on the substrate. Accordingly, in the reflective liquid crystal device, it becomes possible to significantly reduce the spaces between the pixel electrodes to approximately 1×10⁻⁶ m(1 μm).

In the liquid crystal device described above having the reduced spaces between the pixel electrodes, as shown in FIG. 11, the space L between pixel electrodes 100 and 101 provided on one substrate is approximately 1×10⁻⁶ m, and the distance d between a common electrode 102 provided on a substrate opposing the substrate mentioned above and the pixel electrodes 100, 101 is 2×10⁻⁶ m to 4×10⁻⁶ m. As a result, a strong lateral electric field is applied to liquid crystal present in the boundary portion between the pixel electrodes 100 and 101. For example, in the case in which the common electrode 102 is fixed at zero voltage as a ground, +5 volts is applied to the pixel electrode 100, and −5 volts is applied to the pixel electrode 101 so as to control the alignment of the pixel electrodes. When a liquid crystal is used which extends perpendicularly with respect to the substrate by an application of a voltage, as shown in FIG. 12. A lateral electric field having +10 volts, the potential difference between +5 and −5 volts, is generated in liquid crystal in an area corresponding to the pixel electrode 100 and in the vicinity of the pixel electrode 101. Hence, the liquid crystal influenced by this lateral electric field has a high probability of aligning in a direction which is different from that in which the liquid crystal is naturally aligned. That is, in liquid crystal in an area in which the alignment thereof is controlled by the pixel electrode 100, some liquid crystal molecules are aligned in a direction that is slightly different from the alignment direction of other liquid crystal molecules. As a result, a linear display defect, a so-called disclination line, is generated in a boundary area (an area along a boundary line indicated by a reference mark DR in FIG. 12) of the liquid crystal aligned in the slightly different direction. When the width of the linear display defect was actually measured, it was found that the width thereof was approximately 3×10⁻⁶ m (3 μm) on average.

FIG. 14 is a view showing the lightness of a pixel portion in a conventional liquid crystal device, obtained by computing a light reflecting state of the pixel portion. As shown in this figure, it is understood that the luminance in the pixel is degraded at the two sides thereof due to the generation of disclination lines.

In order to reduce the display defects caused by disclination as much as possible, a frame inversion driving method is employed, which is capable of making as many adjacent pixel electrodes as possible to have the same polarities, so that the liquid crystal is driven by applying voltages, having the same polarity, to all pixel electrodes in each frame when display is performed. However, the frame inversion driving method cannot totally solve the problem described above. That is, when white or black display is performed over the entire display area, the frame inversion driving method works effectively, but in a display mode in which white display and black display are present in the display area, the boundary portions of the white and the black display become nearly gray, and the display at the boundary portions is blurred. For example, as shown in FIG. 13, in the case in which a letter “A” is displayed in black on a background displayed in white, a gray area is generated by disclination lines in the white portion around the outline of the black “A”, and the outline of the letter “A” is blurred, whereby the contrast of the display mode is decreased. In particular, in a projection type display apparatus, the situation becomes more serious due to a magnifying projection display.

Other liquid crystal driving methods, in addition to the frame inversion driving method, exists. For example, a line inversion driving method exists in which the polarity of a driving voltage is applied to each longitudinal line or to each lateral line is different from that applied to the line adjacent thereto, and a dot inversion driving method exists in which the polarity of a driving voltage is applied to each pixel electrode is different from that applied to the pixel electrodes adjacent thereto. Since the individual driving methods have their own advantages, it is preferable that various driving methods be selected for projector type liquid crystal panels. However, in view of the generation of inclination lines described above, the problem arises that the line inversion driving method or the dot inversion driving method, in which the difference in potential between the pixel electrodes adjacent to each other is increased, cannot be employed as a driving method for a highly fine liquid crystal panel.

In addition, the first characteristic required for a projector is currently the lightness, and the lightness can be improved by increasing an effective aperture ratio by providing micro lenses corresponding to the pixels so as to converge light at the aperture areas. However, when the micro lens is provided, light flux density entering the pixel is increased. Hence, since the alignment film is damaged, alignment defects of the liquid crystal may occur in some cases. Heretofore, for ease of illustration of the present invention, a color filter and a polarizer provided in the liquid crystal device are not discussed, and the problem relating to the aperture ratio of the panel itself is only described.

### SUMMARY OF THE INVENTION

The present invention was made in consideration of the situations described above. An object of the present invention is to provide a liquid crystal device, a projection type display apparatus, and an electronic apparatus capable of performing bright display, in which the generation of display defects caused by abnormal alignment of liquid crystal is suppressed by defining the specific relationship of the pretilt angle of the alignment film, the spaces between the pixel electrodes, and the thickness of the liquid crystal layer.

To these ends, a liquid crystal device of the present invention includes liquid crystal held between a pair of substrates, each having an alignment film on the surface thereof opposing a surface of the other substrate, a plurality of scanning lines, a plurality of data lines, and switching elements and pixel electrodes provided in individual pixel areas defined by the scanning lines and the data lines. A pretilt angle of the alignment film is in the range of 20 to 30°. According to the structure described above, since the display defects caused by disclination are placed outside the pixels, a black matrix for shading an area in which the disclination is generated is not additionally provided, and hence, brighter display can be ensured corresponding to the area described above.

In the present invention, the alignment film preferably includes one of silicon oxide and silicon nitride. When the alignment film is formed by, for example, an oblique deposition method, using the material described above, a pretilt angle of 20 to 30° is relatively easily realized, and in addition, since the decomposition of the alignment film by light is prevented, the generation of abnormal alignment can be prevented.

In addition, in the present invention, when the thickness (a cell gap) of the liquid crystal layer held between the pair of substrates is represented by d, and when the space between the pixel electrodes is represented by L, d/L is preferably 1 or more. Disclination is increasingly observable as the cell gap d is decreased and as the space between the pixel electrodes is decreased; however, when d/L is set to be 1 or more, the influence of the lateral electric field is decreased, and the aperture ratio can be increased.

Furthermore, in the present invention, the pixel electrode may be a light-reflecting metal electrode. When the pixel electrode is formed of a light-reflecting metal electrode, the switching elements and the wiring can be formed under the pixel electrodes. Accordingly, the pixel electrodes can be disposed independently from the locations of the switching elements and the wiring.

A projection type display apparatus of the present invention includes the liquid crystal device described above, and hence, bright display can be obtained by preventing the display defects caused by disclination.

In particular, when a projection type display apparatus includes a light source, a light modulating device that modulates light emitted from the light source, and a projection lens that projects the light modulated by the light modulating device, and when the liquid crystal device described above is used as the light modulating device, bright display can be obtained by preventing the display defects caused by disclination when magnifying projection is performed.

Similarly to the above, when a projection type display apparatus includes a light source, a light modulating device that modulates light emitted from the light source, and a projection lens that projects the light modulated by the light modulating device, and when the liquid crystal device described above is used for a blue display portion as the light modulating device, display can be obtained having an improved blue purity.

In addition, since an electronic apparatus of the present invention is provided with the liquid crystal device described above, bright display can be obtained by preventing the display defects caused by disclination.

### BRIEF DESCRIPTION OF THE DRAWINGS

FIG. 1 is a view of an equivalent circuit showing the structure of a display area of a TFT substrate in a liquid crystal device according to first embodiment of the present invention;

FIG. 2 is an expanded cross-sectional view showing the structure of one TFT of a TFT array substrate;

FIG. 3 is a schematic view for depicting the relationships of a pixel pitch, a space between pixel electrodes, and the thickness of a liquid crystal layer in the liquid crystal device;

FIG. 4 is a view showing the entire structure of the liquid crystal device;

FIG. 5 is a cross-sectional view taken along the plane H-H′ in FIG. 4;

FIGS. 6(a) to 6(d) are views showing voltage distributions in individual pixels in driving methods applicable to the liquid crystal device;

FIG. 7 is a cross-sectional view showing the structure when a Si substrate is used as a substrate in the liquid crystal device;

FIG. 8 is a view showing the lightness obtained by computing a reflection state of light in the liquid crystal device;

FIG. 9 is a view showing the structure of a liquid crystal projector of an embodiment provided with a liquid crystal device of the present invention;

FIG. 10(a) is a perspective view of a mobile phone, FIG. 10(b) is a perspective view of a wristwatch, and FIG. 10(c) is a perspective view of a portable information processing apparatus;

FIG. 11 is a view showing the positional relationship between a pixel electrode provided for a substrate having elements thereon and a common electrode located at an opposing substrate side in a conventional liquid crystal device;

FIG. 12 is a view showing the state in which disclination is generated in liquid crystal alignment by the influence of a lateral electric field in a conventional liquid crystal device;

FIG. 13 is a view showing the state in which a letter “A” is displayed in black on a white display in a conventional liquid crystal device; and

FIG. 14 is a view showing the lightness obtained by computing light reflection in a state in which disclination is generated in liquid crystal alignment by the influence of a lateral electric field in a conventional liquid crystal device.

### DETAILED DESCRIPTION OF PREFERRED EMBODIMENTS

Hereinafter, the embodiments of the present invention will be described with reference to drawings; however, the present invention is not limited to the embodiments described below.

### First Embodiment

Pixel Portion of a Liquid Crystal Device

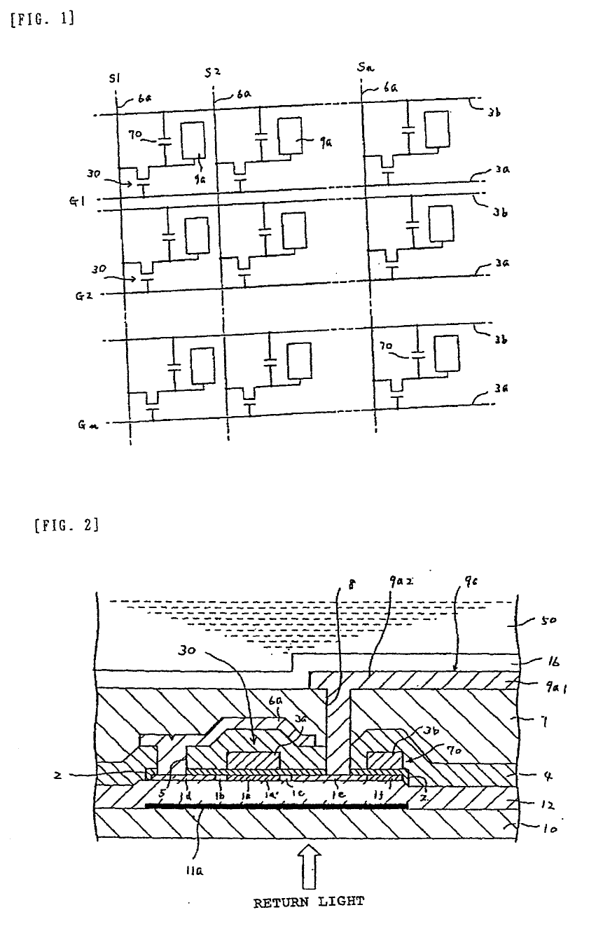

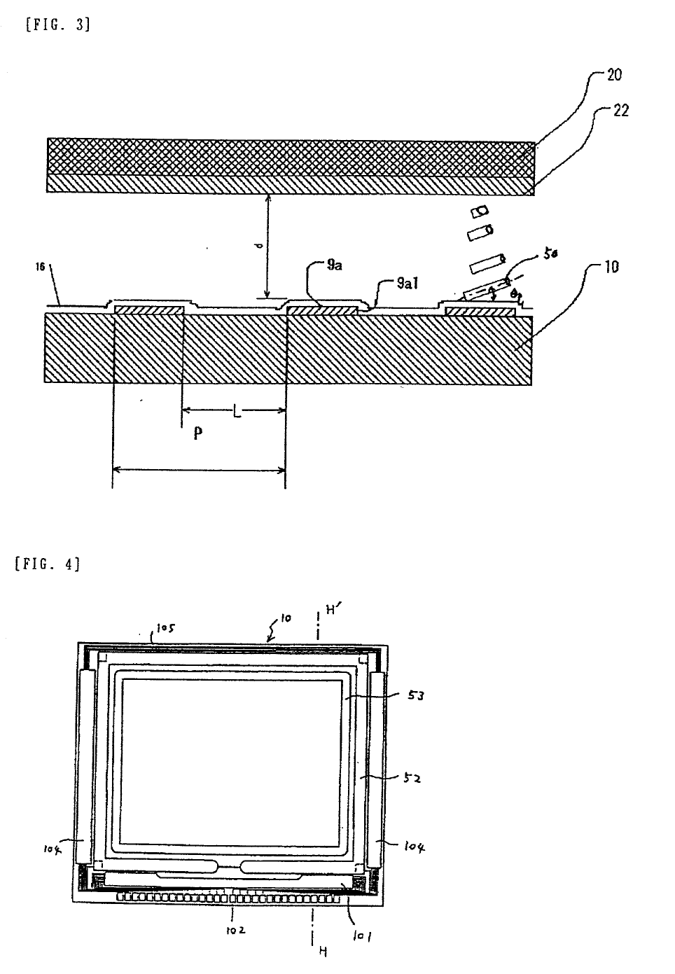

A liquid crystal device of first embodiment of the present invention will first be described. The pixel portion of the liquid crystal device will first be described with reference to FIGS. 1 and 2. FIG. 1 is an equivalent circuit of various types of elements and wiring of a plurality of pixels aligned in a matrix constituting an image display area of the liquid crystal device. FIG. 2 is an enlarged cross-sectional view of a TFT array substrate of one TFT shown in FIG. 1. In this cross-sectional view, in order to make each layer and each member easily recognizable in the figure, the reduction scales of the individual layers and the individual members differ from each other.

In FIG. 1, in the image display area of the liquid crystal device according to this embodiment, m pieces of scanning lines 3a extend in the lateral direction, n pieces of data lines 6a extend in the longitudinal direction, and TFTs 30 and pixel electrodes 9a are aligned in a matrix at locations corresponding to the cross portions of the scanning lines 3a and the data lines 6a. A gate electrode of the TFT 30 is connected to the scanning line 3a, a source electrode of the TFT 30 is connected to the data line 6a, and the drain electrode is connected to the pixel electrode 9a. In addition, scanning signals G1, G2 to Gm, which are sequentially at active levels at a predetermined timing, are applied to the m pieces of scanning lines 3a. Furthermore, while one of the scanning signals is at an active level, image signals S1, S2 to Sn are sequentially fed in this order to the n pieces of data lines 6a or to each group of a plurality of data lines 6a adjacent to each other.

Accordingly, when a scanning signal is at an active level, all TFTs connected to one scanning line 3a to which the scanning signal mentioned above is applied are simultaneously in an on state. In addition, during the period of this on state, the image signals S1, S2 to Sn are written to individual pixel electrodes 9a connected to the scanning line described above and are retained for a predetermined time between the pixel electrodes and opposing electrodes formed on an opposing substrate described below.

Since the alignment and the regularity of the molecular self-organization in liquid crystal are changed in accordance with the level of the voltage applied thereto, light being transmitted through the liquid crystal is modulated, and hence, grayscale display can be performed. When liquid crystal is driven by a normally-white mode, incident light is not allowed to be transmitted through the liquid crystal portion in accordance with a voltage applied thereto, and when a normally-black mode is used, incident light is allowed to be transmitted through the liquid crystal portion in accordance with a voltage applied thereto, whereby, as a whole, light having an intensity in accordance with an image signal is emitted from the liquid crystal device. In order to prevent leakage of the retained image signals, an accumulation capacitor 70 is additionally provided in parallel with a liquid crystal capacitor formed between the pixel electrode 9a and the opposing electrode. By this accumulation capacitor 70, the voltage of the pixel electrode 9a can be held for a time approximately three orders of magnitude longer than the time that a source voltage is applied, and hence, the holding characteristics are improved, whereby a liquid crystal device having a high contrast ratio can be produced.

Next, as shown in the enlarged cross-sectional view of FIG. 2, above the TFT array substrate 10, a pixel switching TFT (a switching element) 30 is provided at a location adjacent to each pixel electrode 9a. In addition, in the pixel electrode 9a, an alignment film 16 is provided at a side opposite to the TFT 30. As described below, the TFT array substrate 10 is adhered to the opposing substrate, having the opposing electrodes and an alignment film formed thereon, with a predetermined gap therebetween, and a liquid crystal layer 50 is formed by filling the liquid crystal in this gap. In addition, when the difference in voltage between the pixel electrode and the opposing electrode is not present, the liquid crystal layer 50 is arranged to be in a predetermined alignment state due to the alignment films provided at the two substrates.

On the TFT array substrate 10, a first shading film 11a is provided at a location opposing the pixel switching TFT 30. The first shading film 11a is preferably formed of a metal element, an alloy, a metal salicide, or the like containing at least one opaque metal having a high melting point selected from titanium (Ti), chromium (Cr), tungsten (W), tantalum (Ta), molybdenum (Mo), and palladium (Pd). When the first shading film 11a is formed of the material mentioned above, the first shading film 11a is not destroyed and is not melted during a subsequent treatment at a high temperature. In addition, the first shading film 11a can prevent return light returned from the TFT array substrate 10 side or the like from entering a channel area 1a′ and lightly doped drain (LDD) areas 1b, 1c of the pixel switching TFT 30, and hence, degradation of the characteristics of the pixel switching TFT 30 can be prevented which is caused by the generation of a photocurrent.

Next, a first interlayer insulating film 12 is provided between the first shading film 11a and a plurality of pixel switching TFT 30. The first interlayer insulating film 12 is provided for electrically insulating a semiconductor layer 1a constituting the pixel switching TFT 30 from the first shading film 11a. In addition, since the first interlayer insulating film 12 is formed over the entire surface of the TFT array substrate 10, the first interlayer insulating film 12 also serves as an underlying layer for the pixel switching TFT 30. That is, the first interlayer insulating film 12 has the function of preventing the characteristics of the pixel switching TFT 30 from being degraded by a roughened surface of the TFT array substrate 10 caused by polishing, stains remaining thereon after washing, or the like. The first interlayer insulating film 12 is formed of, for example, a highly insulating glass, such as a non-doped silicate glass (NSG), a phosphorus silicate glass (PSG), a boron silicate glass (BSG), or a boron phosphorus silicate glass (BPSG); a silicon oxide film; or a silicon nitride film. The first interlayer insulating film 12 described above can also prevent the pixel switching TFT 30 or the like from being polluted by first shading film 11a. When an opaque silicon (Si) substrate is used for the TFT array substrate 10, the first shading film 11a is not required.

Subsequently, a gate insulating film 2 is formed by a thermal oxidation treatment or the like on the surface of the semiconductor layer 1a constituting the pixel switching TFT 30, and in addition, the scanning line 3a formed of polycrystalline silicon is formed. Accordingly, a part of the scanning line 3a crossing the semiconductor layer 1a serves as the gate electrode, and a part of the semiconductor layer 1a under the scanning line 3a serves as the channel area 1a′. In addition, in parts of the semiconductor layer 1a adjacent to the two sides of the channel area 1a′, a lightly doped source area (an LDD area at the source side) 1b and a lightly doped drain area (an LDD area at the drain side) 1c are provided, respectively, and outside these LDD areas, a highly doped source area 1d and a highly doped drain area 1e are provided, respectively, whereby the TFT 30 has a so-called lightly doped drain (LDD) structure. In the individual areas, 1b, 1c, 1d, and 1e are each formed by doping the semiconductor layer 1a with an n-type or a p-type dopant so as to have a predetermined concentration therein depending on whether an n-type or a p-type channel is formed. In this connection, an n-type channel TFT has the advantage in that the processing speed is high, and hence, the n-type channel TFT is used as the pixel switching TFT 30, i.e., a switching element for a pixel, in many cases.

A material used for a pixel electrode 9a in a transmissive display is preferably a transparent conductive film, such as indium tin oxide (ITO), and on the other hand, a conductive film having high reflectivity, such as aluminum (Al) or silver (Ag), may be used for a pixel electrode 9a in a reflective display.

The highly doped source area 1d of the semiconductor layer 1a constituting the TFT 30 is connected to a data line 6a formed of a shading thin-film containing a metal film having a low resistance, such as Al, or an alloy film, such as a metal silicide, via a contact hole 5 penetrating the gate insulating film 2 and a second interlayer insulating film 4, and the highly doped drain area 1e is connected to the associated pixel electrode 9a via a contact hole 8 penetrating the gate insulating film 2, the second interlayer insulating film 4, and a third interlayer insulating film 7. In addition, the highly doped drain area 1e and the pixel electrode 9a may be electrically connected to each other via the same aluminum film as that for the data line 6a or the same polycrystalline silicon film as that for the scanning line 3a.

The TFT 30 preferably has the LDD structure as described above; however, an offset structure may be used in which impurity ion implantation is not performed into the lightly doped source area 1b and into the lightly doped drain area 1c, or a self-align type TFT may be used in which impurity ions are implanted at a higher concentration by using the gate electrode 3a as a mask so as to form a highly doped source area and a highly doped drain area by self-alignment.

In addition, a highly doped area 1f, adjacent to the highly doped drain area 1e of the semiconductor layer 1a constituting the TFT 30, extends to a location at which a capacitor line 3b is formed extending approximately parallel to the scanning line 3a, and the highly doped area 1f has a low resistance. Accordingly, the accumulation capacitor 70 is formed of the highly doped area 1f and a part of the capacitor line 3b with the gate insulating film 2 provided therebetween as a dielectric material. Since the dielectric material of the accumulation capacitor 70 is the gate insulating film 2 itself formed on the polycrystalline silicon film for the TFT 30 by high temperature oxidation, a thin insulating film can be formed having a high breakdown voltage. Consequently, the accumulation capacitor 70 has a large capacitance in a relatively small area.

As a result, by effectively using areas outside the aperture areas, such as an area under the data line 6a, and a space along the scanning line 3a, the accumulation capacitance of the pixel electrode 9a can be increased. In addition, the pixel electrode 9a may be formed above the data line 6a or the scanning line 3a with an insulating film therebetween.

In this embodiment, a single gate structure is formed in which one gate electrode (data line 3a) of the pixel switching TFT 30 is provided between the source and the drain areas 1b and 1e; however, at least two gate electrodes may be provided therebetween. In the case described above, the structure is formed so that the same signal is applied to the individual gate electrodes. When a TFT is formed having a dual gate (a double gate) or a triple gate structure, a leak current at the junctions of the channel with the source and the drain areas can be prevented, and hence, a current in an off state can be decreased. When at least one gate electrode described above is formed having the LDD structure or the off-set structure, the off-set current can be further decreased, and as a result, a stable switching element can be produced.

Next, in the liquid crystal device having the structure described above, the relationship of the pretilt angle of the liquid crystal due to the alignment film, the space between the pixel electrodes 9a, and the thickness of the liquid crystal layer are investigated. For ease of description, as shown in FIG. 3, a space between body portions 9a1 of the pixel electrodes 9a is represented by L(×10⁻⁶ m), an alignment pitch of the pixel electrodes 9a is represented by P(×10⁻⁶ m), and the thickness (a cell gap which is a distance between the alignment film 16 at the substrate 10 side and an alignment film 22 at a substrate 20 side) of the liquid crystal layer is represented by d(×10⁻⁶ m). In addition, an angle (a pretilt angle) formed by the long axis of the liquid crystal molecular and the surface of the substrate (the alignment film) is represented by θp.

In the structure shown in FIGS. 1 and 2, the alignment pitch was set to be 25×10⁻⁶ m, and the size of the pixel electrode 9a was set to be 15×10⁻⁶ by 15×10⁻⁶ m (accordingly, the space L was 10×10⁻⁶ m). In addition, the cell gap d was set to be 5×10⁻⁶ m. Furthermore, the alignment films 16 and 22 were formed of silicon dioxide (SiO₂), an inorganic material, the pretilt angle θp was set to be 25° by an oblique deposition method, and a twist nematic alignment mode was formed having an angle of 45° between the two substrates. In the case described above, the product Δn•d of the refractive anisotropy An and the cell gap d was set to be 0.48×10⁻⁶ m.

In addition, although not shown in the figure, the opposing substrate 20 was provided with microlenses formed of a photosensitive resin, acrylic adhesives covering the microlenses, and cover glasses at the back surface of the substrate (the upper side).

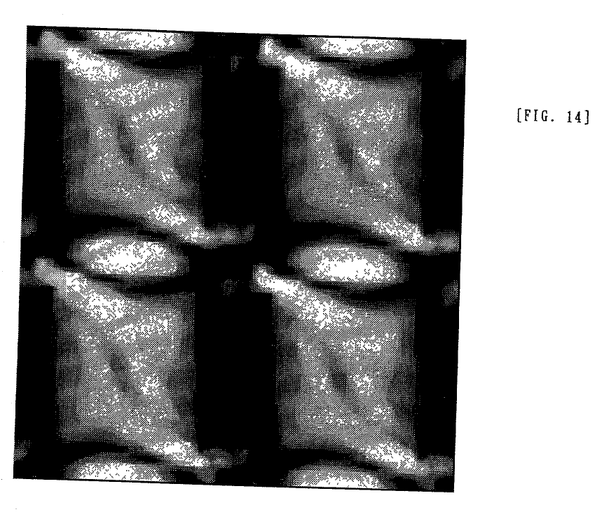

Under the conditions described above, taking the influence of a lateral electric field from the adjacent pixel electrode into consideration, a state of liquid crystal alignment was computed for simulating the lightness obtained in the pixel electrode with respect to the light reflectance. The results are shown in FIG. 8. In this figure, compared to the conventional example shown in FIG. 14, it is understood that display defects are significantly decreased which are caused by disclination.

Subsequently, in the case in which the pretilt angle θp was changed while the Δn•d is fixed to be 0.48 μm, necessary cell gaps d were computed. The results are shown in the table below (Table 1). In this Table, the reflectance obtained when the dot inversion driving method was employed as a driving method and the response speeds thereof obtained by computing are also shown in this Table.

TABLE 1

| Pretilt | | | | | | | |
|---|---|---|---|---|---|---|---|
| Angle | | | | | | | |
| (degree) | 0 | 5 | 10 | 20 | 30 | 40 | 50 |
| Δn | 0.15 | 0.148 | 0.145 | 0.13 | 0.108 | 0.08 | 0.057 |
| Cell | 3.2 | 3.24 | 3.31 | 3.7 | 4.4 | 6 | 8.4 |
| Thickness | | | | | | | |
| Reflect- | 42 | 44 | 45 | 56 | 60 | 62 | 63 |
| ance (%) | | | | | | | |
| Response | 46 | 47 | 50 | 62.7 | 72 | 165 | 324 |
| Time (ms) | | | | | | | |

As can be seen in Table 1, it is understood that the cell gap d is increased when the pretilt angle θp is 30° or more. In addition, since it is known that the response time is increased in proportion to the square of the cell gap d, it is not preferable to increase the cell gap d. Furthermore, the reflectance is decreased when the pretilt angle θp is 20° or less, since disclination occurs. Accordingly, it is considered that the pretilt angle θp is preferably set in the range of 20 to 30°.

As described above, since the influence of the lateral electric field is increased as the cell gap is decreased and as the space L between the pixel electrodes is deceased, the influence can be apparently observed in a highly fine panel. In addition, as shown in Table 1, the response time is increased as the cell gap d is increased, and concerning the lightness, when the cell gap d is decreased in order to maintain the Δn•d at a constant value, a liquid crystal material having a high Δn is required. However, since reliable liquid crystal is very limited having a high Δn, liquid crystal having a high Δn is not advantageously used from an operational point of view.

Next, in the case in which the alignment pitch P of the pixel electrodes 9a was set to be 10 μm, and the cell gap d was maintained at a constant value of 3.2 μm, the change in aperture ratio depending on the change in space L between the pixel electrodes was measured. The results are shown in the table below

TABLE 2

| L (μm) | 1 | 2 | 3 | 4 |
|---|---|---|---|---|
| d (μm) | 3.2 | 3.2 | 3.2 | 3.2 |
| d/L | 3.2 | 1.6 | 1.06 | 0.8 |
| Aperture Ratio | 81 | 64 | 49 | 36 |
| (%) | | | | |
| Maximum | 300 | 250 | 200 | 180 |
| Contrast | | | | |

The pretilt angle θp is set in the range of 20 to 30°. In order to decrease the influence of the lateral electric field and to obtain a high contrast by increasing the aperture ratio, the relationship between the cell gap d and the space L, i.e., d/L, must be 1 more. Even though a high aperture ratio can be obtained by decreasing the space between the pixel electrodes in the case of a normally-white display mode, light leakage occurs in black display due to the generation of the lateral electric field. As a result, bright display having a high contrast cannot be obtained due to the light leakage even though the aperture ratio is high. The contrast required for a liquid crystal device for use in a current projection type apparatus is 200 or more. In order to achieve this contrast, the conditions described above are necessary.

Accordingly, when the pretilt angle θp is set in the range of 20 to 30°, and when the cell gap d and the space L are set such that d/L is 1 more, the generation of disclination lines is unlikely to occur in the pixel electrode, even if there is the influence of the lateral electric fields by other pixel electrodes adjacent thereto. As a result, even though the display structure is finely designed, display having high quality and a high contrast can be performed.

Entire Structure of Liquid Crystal Device

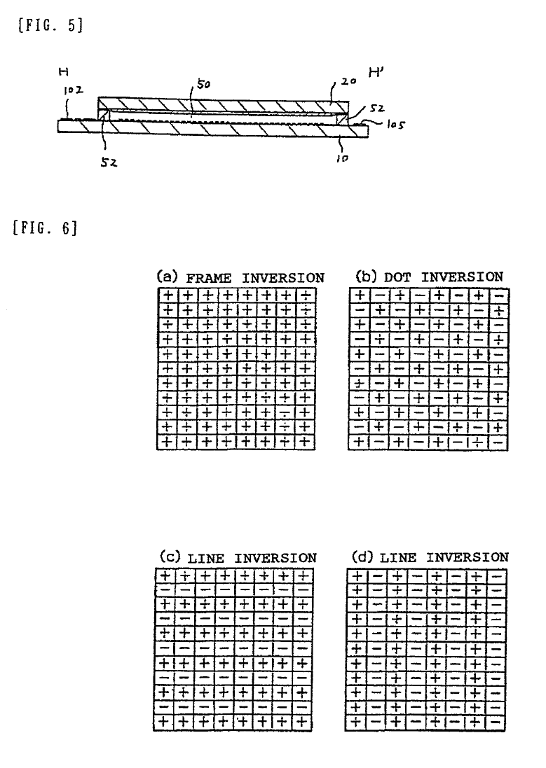

Next, the entire structure of the liquid crystal device according to this embodiment will be described with reference to FIGS. 4 and 5. In FIG. 4, on the TFT array substrate 10, a sealing material 52 is provided along the periphery thereof, and along the sealing material 52 and inside thereof, a shading film 53 is provided for defining the periphery. In an area outside the sealing material 52, a data line driving circuit 101 and a mount terminal 102 are provided along one side of the TFT array substrate 10, and along two sides thereof adjacent to the side mentioned above, scanning line driving circuits 104 are provided. When delay of scanning signals supplied to the scanning lines 3a is not a problem, the scanning line driving circuit 104 is naturally provided along one of the two sides described above. In addition, the data line driving circuits 101 may be provided along two sides of the image display area. Furthermore, along the remaining side of the TFT array substrate 10, a plurality of wires 105 are provided for interconnecting the scanning line driving circuits 104 provided along the two sides of the image display area. As shown in FIG. 5, the opposing substrate 20 having an outline approximately equivalent to that of the sealing material 52 is bonded to the TFT array substrate 10 with a predetermined gap d therebetween by the sealing material 52, and liquid crystal is enclosed in the space thus formed, whereby the liquid crystal layer 50 is formed. The sealing material 52 is an adhesive formed of, for example, a photocurable resin, or a thermosetting resin, and to the sealing material 52, spacers (not shown in the figure) in the form of a bar or a sphere are added so that the predetermined gap d can be maintained.

At a side at which projection light from the opposing substrate 20 enters and at a side at which outgoing light from the TFT array substrate 10 emits, polarizing films, retardation films, polarizers, or the like are optionally provided in predetermined directions, respectively, in accordance with, for example, an operation mode, such as a twisted nematic (TN) mode, a super TN (STN) mode, or a ferroelectric liquid crystal (FLC) mode; or a normally-white mode or a normally-black mode.

Since the liquid crystal device of the embodiment described above is applied to a color liquid crystal projector, three liquid crystal devices are used as light valves for red, green and blue (RGB), and light having a color separated by a dychroic mirror that separates colors into RGB is entered into each liquid crystal device as projection light.

Accordingly, in this embodiment, a color filter is not provided at the opposing substrate 20 side. However, on the opposing substrate 20, a color filter for RGB may be provided with a protective film at areas corresponding to the pixel electrodes 9a Accordingly, in addition to the liquid crystal projectors, the liquid crystal devices of the embodiments may be applied to various color liquid crystal apparatuses, such as a direct view type or a reflective type color liquid crystal television. In addition, by forming a laminate formed of a plurality of interference films having different refractive indexes on the opposing substrate 20, a dychroic filter producing RGB may be formed by using interference of light. By the opposing substrate provided with this dychroic filter, a brighter color liquid crystal apparatus can be produced.

In addition, as the switching element provided in each pixel, the normal stagger type or the coplanar type TFT composed of polycrystalline silicon may be used; however, other TFT, such as an inverted stagger TFT, or a TFT formed of amorphous silicon, may be effectively used in the embodiment.

In this embodiment, the pixel electrodes 9a are driven by using TFTs; however, in addition to TFT, an active matrix device, such as a thin-film diode (TFD), may also be used. In addition, the liquid crystal device may be formed as a passive matrix liquid crystal device.

FIG. 6 is a view for illustrating driving methods applicable to the liquid crystal device of this embodiment when it is driven. First, when each rectangular area defined by lines shown in FIG. 6(a) is assumed to be one pixel, a method for applying voltages having the same polarity to all pixels enclosed by a frame may be employed, in other words, a frame inversion driving method for repeatedly applying voltages to individual frames may be employed in which a positive potential is applied to every pixel enclosed by the frame shown in FIG. 6(a), and a negative potential is applied to every pixel enclosed by the other frame which is not shown. Second, as shown in FIG. 6(b), a dot inversion driving method may be employed in which voltages having different polarities are applied to individual pixels adjacent to each other located from right to left and from top to bottom. Third, as shown in FIG. 6(c), a method for applying different voltages to lines adjacent to each other in the lateral direction or, as shown in FIG. 6(d), a method for applying different voltages to lines adjacent to each other in the longitudinal direction may be employed.

In a conventional highly fine liquid crystal device having the structure in which spaces between pixel electrodes are decreased to approximately 1×10⁻⁶ m, the frame inversion driving method is the only method to be employed due to the influence of the lateral electric field. The reason for this is that when the dot inversion driving or the frame inversion driving is performed, display defects may occur in some cases due to the generation of disclination lines. In contrast, when the structure of this embodiment is employed, even when a driving method is employed in which voltages having different polarities are applied to the pixels adjacent to each other, the generation of disclination lines in the display area is decreased. As a result, when the dot inversion driving method shown in FIG. 6(b) or the line inversion driving method shown in FIGS. 6(c) or 6(d) is employed, the generation of the disclination can be suppressed. Accordingly, since both driving methods can be used for the liquid crystal device of this embodiment, the applications thereof can be increased more.

### Second Embodiment

Next, a liquid crystal device of Embodiment 2 of the present invention will be described. In this liquid crystal device, a TFT array substrate corresponding to the TFT array substrate 10 of first embodiment is formed of a semiconductor substrate, and active elements for switching pixels are formed in the semiconductor substrate. In the case described above, since the semiconductor substrate has no light-transmitting characteristics, the liquid crystal device is used as a reflective type device.

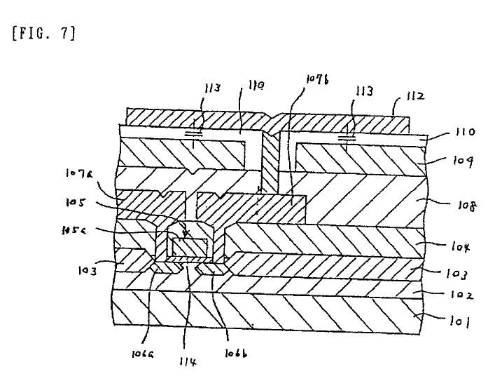

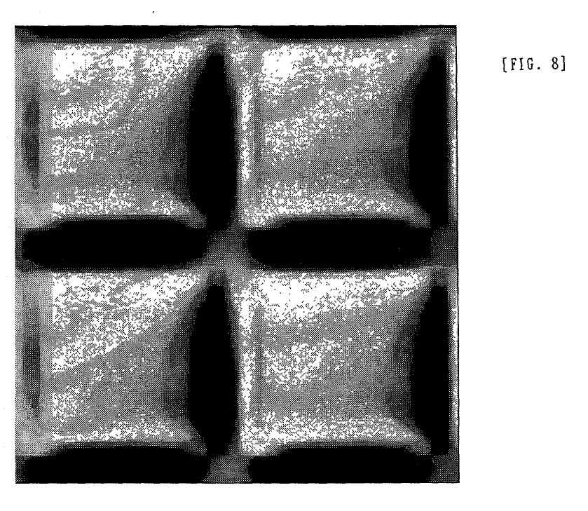

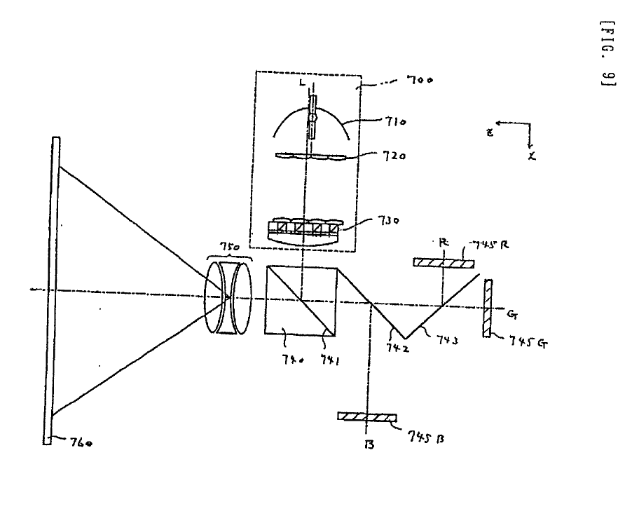

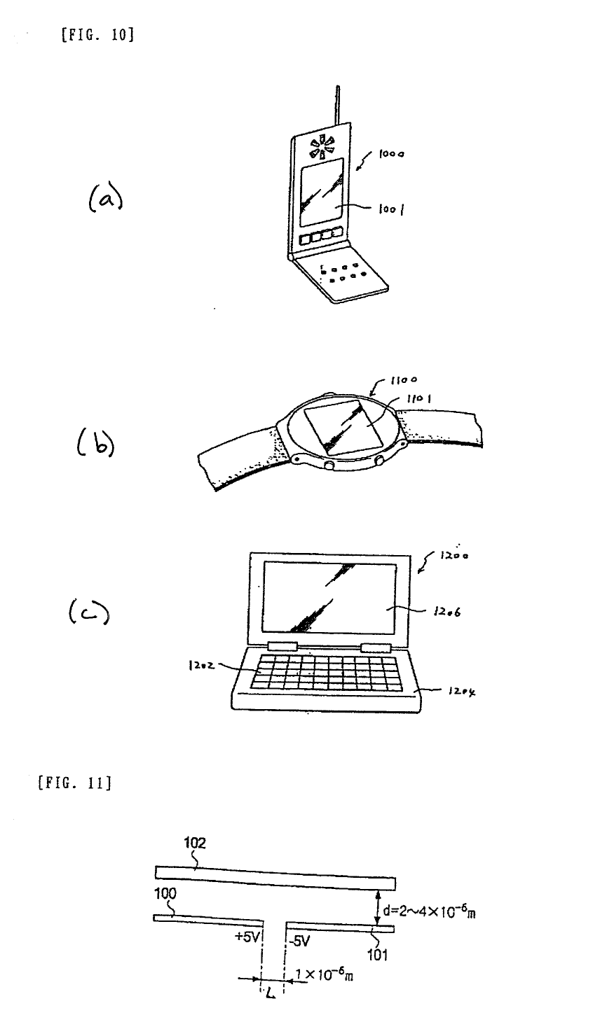

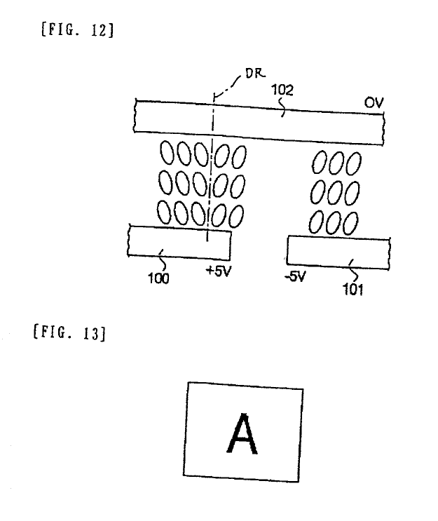

FIG. 7 is a cross-sectional view showing the structure of one field effect transistor for switching a pixel in a reflective liquid crystal device according to this embodiment. The equivalent circuit of this liquid crystal device is not different from that shown in first embodiment.

In the figure, reference numeral 101 indicates a p-type or a n-type semiconductor substrate similar to single crystalline silicon, and reference numeral 102 indicates a p-type or a n-type well area, having a higher impurity concentration than the substrate, formed on the surface of the semiconductor substrate 101. The well area 102 is not specifically limited; however, in the case of a highly fine liquid crystal panel having not less than seven hundred and sixty-eight pixels in the longitudinal direction by one thousand and twenty-four pixels in the lateral direction, the well areas for these pixels are formed as a common well area, and in some cases, the common well area may be formed separately from well areas at which elements are formed constituting other units, such as a data line driving circuit, a scanning line driving circuit, and a peripheral circuit including an input-output circuit, a timing circuit, and the like.

Next, reference numeral 103 indicates a field oxide film (a so-called local oxidation of silicon, LOCOS) formed above the surface of the semiconductor substrate 101. The field oxide film 103 is formed by, for example, selective thermal oxidation. An opening is formed in the field oxide film 103, a scanning line and a gate electrode 105a formed of polycrystalline silicon, a metal silicide, or the like is formed at a central portion inside the opening via a gate oxide film 114 formed by thermal oxidation of the surface of the silicon substrate, and a source area 106a and a drain area 106b, each formed of a n-type impurity doped layer (a doped layer) having a higher impurity concentration than the well area 102, are formed at the substrate surface side and at two sides of the gate electrode 105a, whereby a field effect transistor (FET, a switching element) 105 is formed.

Above the source area 106a and the drain area 106b, first conductive layers 107a, 107b formed of a first aluminum layer is formed with a first interlayer insulating film 104 formed of a boron phosphorus silicate glass (BPSG) or the like provided therebetween. The first conductive layer 107a is electrically connected to the source area 106a via a contact hole formed in the first interlayer insulating film 104 and forms a source electrode (corresponding to the data line) applying a voltage of the data signal to the source area 106aIn addition, the first conductive layer 107b forms a drain electrode formed in the first interlayer insulating film 104.

Next, a second interlayer insulating film 108 formed of silicon dioxide or the like is formed on the conductive layers 107a, 107b, and in addition, a second conductive layer 109 formed of an aluminum layer or a tantalum layer is formed on the second interlayer insulating film 108.

Furthermore, on the second conductive layer 109, an insulating layer 110 is formed of a material having a high dielectric constant, such as silicon dioxide, silicon nitride, or tantalum oxide, and a pixel electrode 112, which is formed of a light-reflecting metal and which is connected to the drain electrode 107b, is formed on the insulating layer 110. The pixel electrode 112 described above and the second conductive layer 109 are formed with the insulating layer 110 provided therebetween. As a result, holding capacitors 113 are formed. Accordingly, the second conductive layer 109 is preferably planarized at the surface thereof. In the structure described above, wiring is electrically connected to the second conductive layer 109 for applying one predetermined potential of an approximate common electrode potential Vcom in the liquid crystal panel, an approximate central potential of an amplitude of a voltage (a data signal voltage) applied to the pixel electrode (a reflection electrode) 112, and an intermediate potential between the common electrode potential and the central potential of the voltage amplitude described above. The common electrode potential Vcom corresponds to the reversal central potential in polarity reversal driving of the liquid crystal layer.

The pixel electrodes 112 shown in FIG. 7 are aligned in a matrix form as viewed via plan view as is the case in first embodiment, the alignment film not shown in the figure is formed on these pixel electrodes 112, an opposing substrate equivalent to that in first embodiment is disposed at a side opposing the semiconductor substrate 101, and a liquid crystal layer is formed between the substrates, whereby a reflective type liquid crystal display apparatus is formed.

In the semiconductor substrate 101 of the liquid crystal display apparatus according to this second embodiment, when the pretilt angle θp is set in the range of 20 to 30° C., and in addition, when the relationship between the cell gap d and the space L is set such that d/L is 1 more, the generation of disclination lines is unlikely to occur in the pixels influenced by the lateral electric field generated in other pixels adjacent thereto. As a result, even though the display structure is finely designed, display having high quality and a high contrast can be performed.

Projector

Next, some applications using the liquid crystal device of the embodiment described above will be described. First, a projection type display apparatus (a liquid crystal projector) will be described. FIG. 9 is a view showing the structure of the liquid crystal projector.

The liquid crystal projector includes a polarizing illumination device that has a light source 710 provided along a system optical axis L; an integrator lens 720, and a polarizing converter 730. The liquid crystal projector also includes a polarizing beam splitter 740 having an S polarized beam reflection surface 741 that reflects the S polarized beam emitted from the polarizing illumination device 700; a dychroic mirror 742 that separates a blue light (B) component from light reflected by the S polarized beam reflection surface 741 of the polarizing beam splitter 740; a reflective liquid crystal light valve 745B that modulates the separated blue light (B); a dychroic mirror 743 that separates a red light (R) component by reflection from beam obtained after the blue light component is separated; a reflective liquid crystal light valve 745R that modulates the separated red light (R); a reflective liquid crystal light valve 745G that modulates remaining light, i.e., green light (G), transmitted through the dychroic mirror 743; and a projection optical system 750 which combines the light modulated by the three reflective liquid crystal light valves 745R, 745G, and 745B, and which projects the combined light on a screen 760. In this structure, reflective liquid crystal devices (liquid crystal panels) of the embodiment are used for the three reflection liquid crystal light valves 745R, 745G, and 745B.

In the structure described above, after the random polarized beam emitted from the light source 710 is divided into a plurality of intermediate beams by the integrator lens 720, the intermediate beams are converted into a type of polarized beam (the S polarized beam), in which the polarized direction is approximately uniform, by the polarizing converter 730 having a second integrator lens at an incident light side thereof, and reaches the polarizing beam splitter 740. The S polarized beam emitted from the polarizing converter 730 is reflected by the S polarized beam reflection surface 741 of the polarizing beam splitter 740, and of the reflected beam, blue beam (B) is reflected by a blue reflection layer of the dychroic mirror 742 and is then modulated by the reflective liquid crystal light valve 745B. Of the beam transmitted through the blue light reflection layer of the dychroic mirror 742, red (R) beam is reflected by a red light reflection layer of the dychroic mirror 743 and is then modulated by the reflective liquid crystal light valve 745R. In addition, green (G) beam transmitted through the red light reflection layer is modulated by the reflective liquid crystal light valve 745G. As described above, color light is modulated by each reflective liquid crystal light valves 745R, 745G, and 745B.

The S polarized component of the light colors reflected by the pixels of the liquid crystal panel is not transmitted through the polarizing beam splitter 740 reflecting S polarized light, but P polarized component is transmitted therethrough. The light transmitted through the polarizing beam splitter 740 forms an image. Accordingly, in the case in which a TN liquid crystal is used in a liquid crystal panel, reflective light at an OFF pixel reaches the projection optical system 750, and reflective light at an On pixel does not reach a lens, whereby a projection image is normally-white display.

In addition, when the liquid crystal device of the embodiment is specifically used for the blue light valve 745B, and the cut-off wavelength of blue light is set to be 400 nm, display having improved color purity can be obtained.

Compared to a type having TFT arrays on a glass substrate, in the reflective liquid crystal panel, since the pixels are formed by using a semiconductor technique, a larger number of pixels can be formed, the panel size can also be reduced, highly fine images can be projected, and in addition, the projector itself can be miniaturized.

Electronic Apparatus

Next, particular examples of electronic apparatuses provided with one of the liquid crystal devices of the embodiments will be described. FIG. 10(a) is a perspective view showing an example of a mobile phone. In FIG. 10(a), reference numeral 1000 indicates a mobile phone body, and reference numeral 1001 indicates a liquid crystal display portion using the liquid crystal device of the embodiment.

FIG. 10(b) is a perspective view showing an example of a wristwatch type electronic apparatus. In FIG. 10(b), reference numeral 1100 indicates a watch body, and reference numeral 1101 indicates a liquid crystal display portion using one of the liquid crystal devices of the embodiments.

FIG. 10(c) is a perspective view showing an example of a portable information processing apparatus, such as a word processor, or a personal computer. In FIG. 10(c), reference numeral 1200 indicates an information processing apparatus, reference numeral 1202 indicates an input portion, such as a keyboard, reference numeral 1204 indicates an information processing body, and reference numeral 1206 indicates a liquid crystal display portion using the liquid crystal device of the embodiment.

Since these electronic apparatuses described above are provided with the liquid crystal devices in accordance with the invention, highly fine display can be obtained having a high contrast ratio.

As has thus been described, according to the present invention, bright display can be obtained by suppressing the generation of the display defects caused by abnormal alignment of the liquid crystal.

What is claimed is:

1. A liquid crystal device, comprising:
first and second substrates, the first substrate having a surface proximate the second substrate, the second substrate being a surface proximate the first substrate; an alignment film disposed at each of the surfaces of the first and second substrates;
liquid crystal disposed between the first and second substrates;
a plurality of scanning lines;
a plurality of data lines;
pixel areas defined by the scanning lines and the data lines;
a switching element provided in each pixel area; and
a pixel electrode provided in each pixel area;
wherein a pretilt angle due to the alignment film is 20° to 30°.

2. The liquid crystal device according to claim 1, the alignment film including one of silicon oxide and silicon nitride.

3. The liquid crystal device according to claim 2, if a thickness of the liquid crystal disposed between the first and second substrates is represented as d, and a space defined between the pixel electrodes is represented as L, a ratio d/L is at least 1.

4. The liquid crystal device according to claim 1, the pixel electrode being a light-reflecting metal electrode.

5. A projection type display apparatus, comprising the liquid crystal device according to claim 1.

6. A projection type display apparatus, comprising:
a light source;
a light modulating device that modulates light emitted from the light source, the light modulating device including the liquid crystal device according to claim 1; and
a projection lens that projects the light modulated by the light modulating device.

7. A projection type display apparatus, comprising:
a light source;
a light modulating device that modulates light emitted from the light source, the light modulating device including the liquid crystal device according to claim 1 that modulates light in a blue display portion; and
a projection lens that projects the light modulated by the light modulating device.

8. An electronic apparatus, comprising the liquid crystal device according to claim 1.
